(19) United States
(12) Patent Application Publication
(10) Pub. No.: US 2005/0022245 A1
(43) Pub. Date: Jan. 27, 2005

(54) Seamless transition between video play-back modes

(76) Inventors: Ramesh Nallur, Duluth, GA (US); Arturo A. Rodriguez, Norcross, GA (US)

Correspondence Address: Scientific-Atlanta, Inc.;Intellectual Property Dept. MS 4.3.510, 5030 Sugarloaf Parkway, Lawrenceville, GA, 30044, US

(21) Appl. No.: 10/623,683

(22) Filed: Jul. 21, 2003

(51) Int. Cl. H04N 7/173

(52) U.S. Cl. 725/88; 725/105; 725/90

(57) ABSTRACT

A method for providing a seamless transition between video play-back modes includes decoding a current video picture, determining a time value corresponding to the current video picture, and storing the time value in memory. Systems and other methods for providing a seamless transition between video play-back modes are also disclosed.

### FIELD OF THE INVENTION

The present invention is generally related to video, and more particularly related to providing video play-back modes (also known as trick-modes).

### BACKGROUND OF THE INVENTION

Digital video compression methods work by exploiting data redundancy in a video sequence (i.e., a sequence of digitized pictures). There are two types of redundancies exploited in a video sequence, namely, spatial and temporal, as is the case in existing video coding standards. A description of some of these standards can be found in the following publications, which are hereby incorporated herein by reference in their entireties:
(1) ISO/IEC International Standard IS 11172-2, “Information technology—Coding of moving pictures and associated audio for digital storage media at up to about 1.5 Mbits/s—Part 2: video,” 1993;
(2) ITU-T Recommendation H-262 (1996): “Generic coding of moving pictures and associated audio information: Video,” (ISO/IEC 13818-2);
(3) ITU-T Recommendation H.261 (1993): “Video codec for audiovisual services at px64 kbits/s”; and
(4) Draft ITU-T Recommendation H.263 (1995): “Video codec for low bitrate communications.”

The playback of a compressed video file that is stored in hard disk typically requires the following: a) a driver that reads the file from the hard disk into main system memory and that remembers the current file pointer from where the compressed video data is read; and b) a video decoder (e.g., MPEG-2 video decoder) that decodes the compressed video data. During a “play” operation, compressed video data flows through multiple repositories from a hard disk to its final destination (e.g., an MPEG decoder). For example, the video data may be buffered in a storage device's output buffer, in the input buffers of interim processing devices, or in interim memory, and then transferred to a decoding system memory that stores the video data while it is being de-compressed. Direct memory access (DMA) channels may be used to transfer compressed data from a source point to the next interim repository or destination point in accomplishing the overall delivery of the compressed data from the storage device's output buffer to its final destination.

Transfers of compressed data from the storage device to the decoding system memory are orchestrated in pipeline fashion. As a result, such transfers have certain inherent latencies. The intermediate data transfer steps cause a disparity between the location in the video stream that is identified by a storage device pointer, and the location in the video stream that is being output by the decoding system. In some systems, this disparity can amount to many video frames. The disparity is non-deterministic as the amount of compressed video data varies responsive to characteristics of the video stream and to inter-frame differences.

The problem is pronounced in systems capable of executing multiple processes under a multi-threaded and pre-emptive real-time operating system in which a plurality of independent processes compete for resources in a non-deterministic manner. Therefore, determining a fixed number of compressed video frames trapped in the delivery pipeline is not possible under these conditions. As a practical consequence, when a user requests a trick mode (e.g., fast forward, fast reverse, slow motion advance or reverse, pause, and resume play, etc.) the user may not be presented with a video sequence that begins from the correct point in the video presentation (i.e., a new trick mode will not begin at the picture location corresponding to where a previous trick mode ended). Therefore, there exists a need for systems and methods that address these and/or other problems associated with providing trick modes associated with compressed video data.

### BRIEF DESCRIPTION OF THE DRAWINGS

Embodiments of the invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a high-level block diagram depicting a non-limiting example of a subscriber television system.

FIG. 2 is a block diagram of an STT in accordance with one embodiment of the present invention.

FIG. 3 is a block diagram of a headend in accordance with one embodiment of the invention.

FIG. 4 is a flow chart depicting a non-limiting example of a method that is implemented by the STT depicted in FIG. 2.

FIG. 5 is a flow chart depicting a non-limiting example of a method that is implemented by the STT depicted in FIG. 2.

FIG. 6 is a flow chart depicting a non-limiting example of a method that is implemented by the STT depicted in FIG. 2.

FIG. 7 is a flow chart depicting a non-limiting example of a method that is implemented by the STT depicted in FIG. 2.

FIG. 8 is a flow chart depicting a non-limiting example of a method in accordance with one embodiment of the present invention.

### DETAILED DESCRIPTION OF THE PREFERRED EMBODIMENTS

Preferred embodiments of the invention can be understood in the context of a subscriber television system comprising a set-top terminal (STT). In one embodiment of the invention, an STT receives a request (e.g., from an STT user) for a trick mode in connection with a video presentation that is currently being presented by the STT. Then, in response to receiving the request, the STT uses information provided by a video decoder within the STT to implement a trick mode beginning from a correct location within the compressed video stream to effect a seamless transition in the video presentation without significant temporal discontinuity. In one embodiment, among others, the seamless transition is achieved without any temporal discontinuity. This and other embodiments will be described in more detail below with reference to the accompanying drawings.

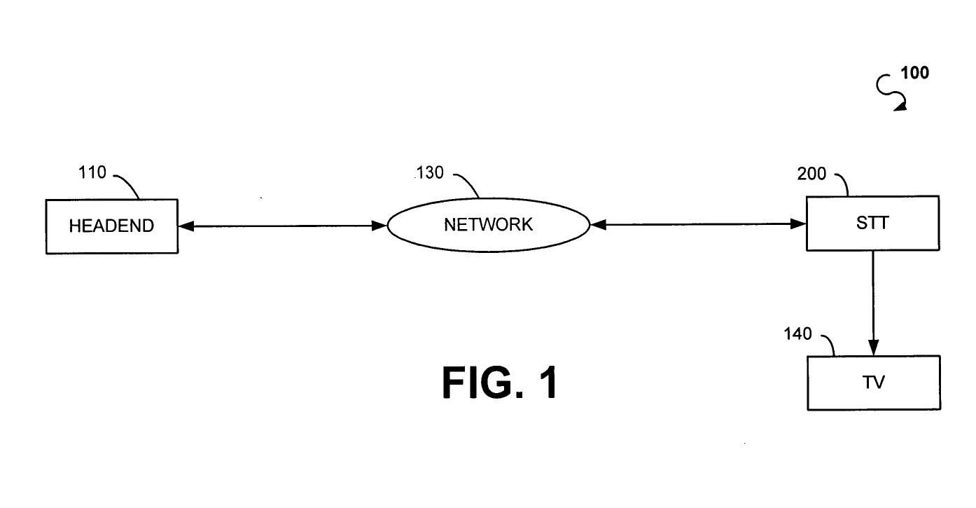

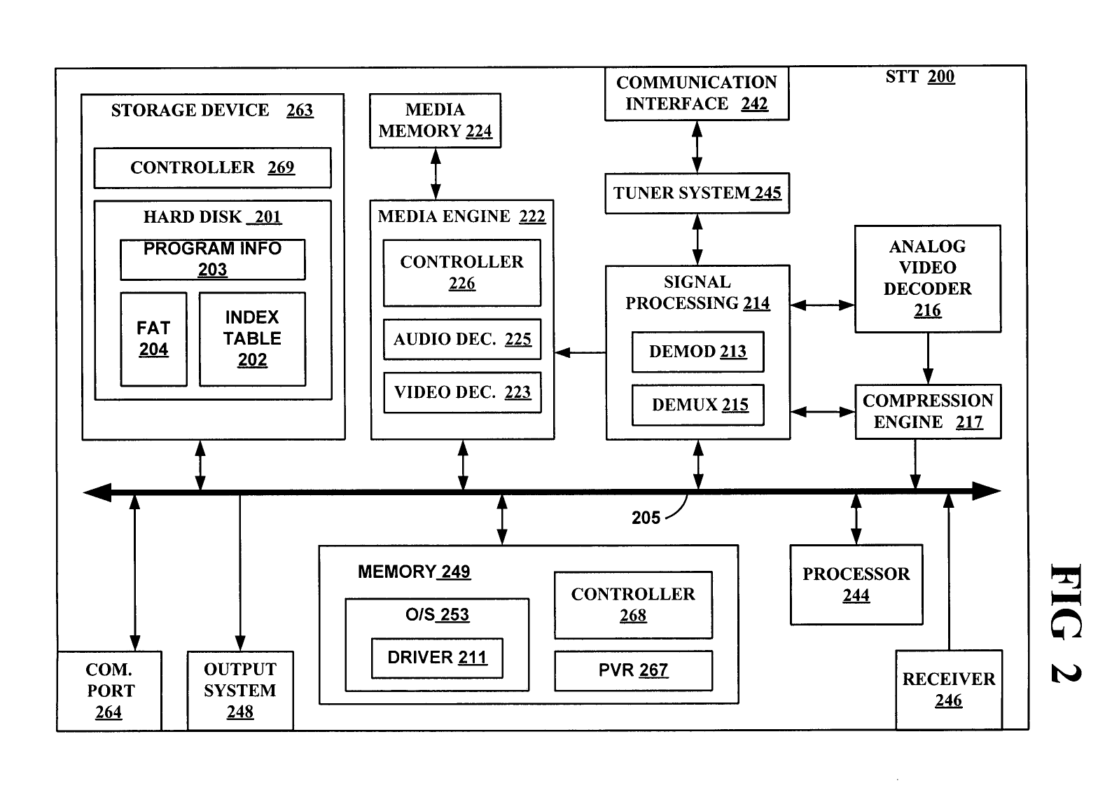

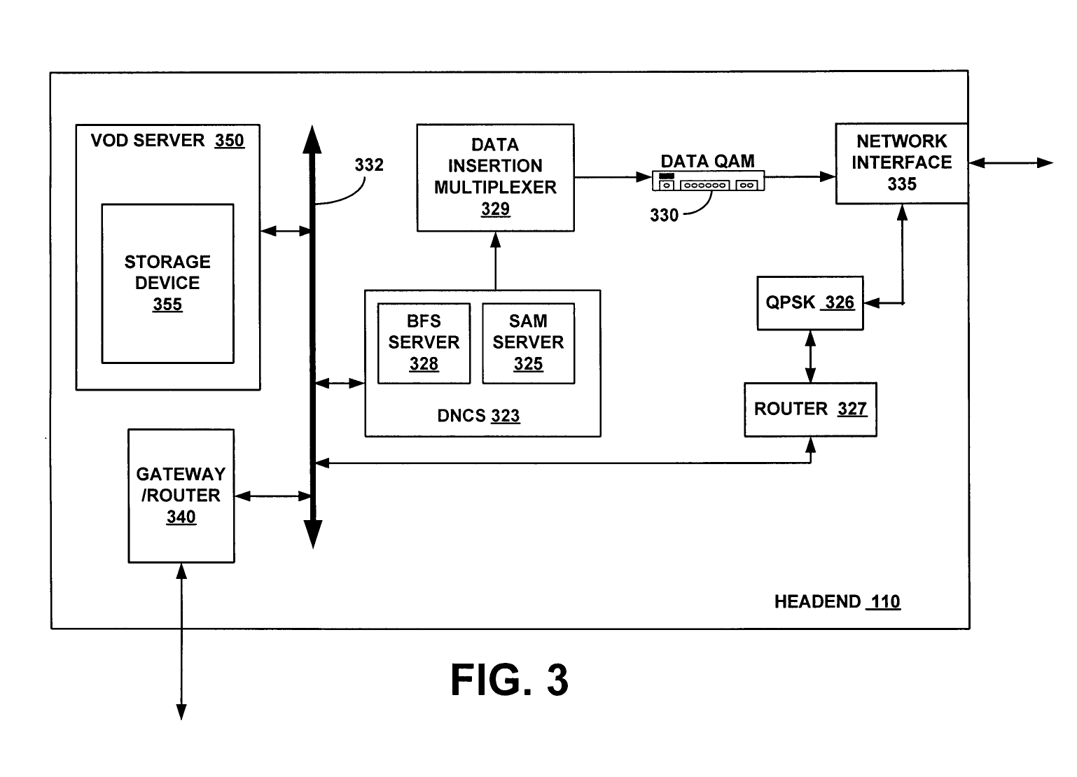

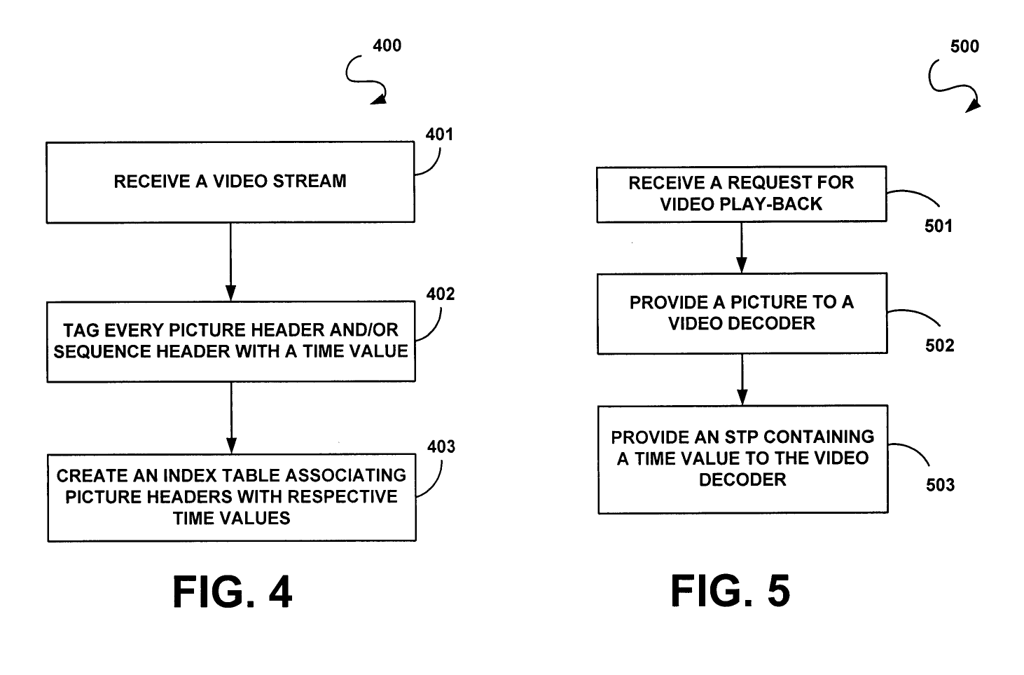

The accompanying drawings include seven figures (FIGS. 1-7): FIG. 1 provides an example of a subscriber television system in which a seamless transition between video play-back modes may be implemented; FIG. 2 provides an example of an STT that may be used to implement the seamless transition; FIG. 3 provides an example of a headend that may be used to help implement seamless transition; and FIGS. 4-8 are flow charts depicting methods that can be used in implementing the seamless transition. Note, however, that the invention may be embodied in many different forms and should not be construed as limited to the embodiments set forth herein. Furthermore, all examples given herein are intended to be non-limiting, and are provided in order to help clarify the invention.

FIG. 1 is a block diagram depicting a non-limiting example of a subscriber television system 100. Note that the subscriber television system 100 shown in FIG. 1 is merely illustrative and should not be construed as implying any limitations upon the scope of the preferred embodiments of the invention. In this example, the subscriber television system 100 includes a headend 110 and an STT 200 that are coupled via a network 130.

The STT 200 is typically situated at a user's residence or place of business and may be a stand-alone unit or integrated into another device such as, for example, the television 140. The headend 110 and the STT 200 cooperate to provide a user with television functionality including, for example, television programs, an interactive program guide (IPG), and/or video-on-demand (VOD) presentations.

The headend 110 may include one or more server devices for providing video, audio, and textual data to client devices such as STT 200. For example, the headend 110 may include a Video-on-demand (VOD) server that communicates with a client VOD application in the STT 200. The STT 200 receives signals (e.g., video, audio, data, messages, and/or control signals) from the headend 110 through the network 130 and provides any reverse information (e.g., data, messages, and control signals) to the headend 110 through the network 130. Video received by the STT 200 from the headend 110 may be, for example, in an MPEG-2 format, among others.

The network 130 may be any suitable system for communicating television services data including, for example, a cable television network or a satellite television network, among others. In one embodiment, the network 130 enables bi-directional communication between the headend 110 and the STT 200 (e.g., for enabling VOD services).

FIG. 2 is a block diagram illustrating selected components of an STT 200 in accordance with one embodiment of the present invention. Note that the STT 200 shown in FIG. 2 is merely illustrative and should not be construed as implying any limitations upon the scope of the preferred embodiments of the invention. For example, in another embodiment, the STT 200 may have fewer, additional, and/or different components than illustrated in FIG. 2. The STT is configured to provide a user with video content received via analog and/or digital broadcast channels in addition to other functionality, such as, for example, recording and playback of video and audio data. The STT 200 preferably includes at least one processor 244 for controlling operations of the STT 200, an output system 248 for driving the television 140, and a tuner system 245 for tuning to a particular television channel or frequency and for sending and receiving various types of data to/from the headend 110.

The tuner system 245 enables the STT 200 to tune to downstream media and data transmissions, thereby allowing a user to receive digital or analog signals. The tuner system 245 includes, in one implementation, an out-of-band tuner for bi-directional quadrature phase shift keying (QPSK) data communication and a quadrature amplitude modulation (QAM) tuner (in band) for receiving television signals. The STT 200 may, in one embodiment, include multiple tuners for receiving downloaded (or transmitted) data.

In one implementation, video streams are received in STT 200 via communication interface 242 and stored in a temporary memory cache. The temporary memory cache may be a designated section of memory 249 or another memory device connected directly to the signal processing device 214. Such a memory cache may be implemented and managed to enable data transfer operations to the storage device 263 without the assistance of the processor 244. However, the processor 244 may, nevertheless, implement operations that set-up such data transfer operations.

The STT 200 may include one or more wireless or wired interfaces, also called communication ports 264, for receiving and/or transmitting data to other devices. For instance, the STT 200 may feature USB (Universal Serial Bus), Ethernet, IEEE-1394, serial, and/or parallel ports, etc. STT 200 may also include an analog video input port for receiving analog video signals. Additionally, a receiver 246 receives externally-generated user inputs or commands from an input device such as, for example, a remote control.

Input video streams may be received by the STT 200 from different sources. For example, an input video stream may comprise any of the following, among others:
1. Broadcast analog audio and/or video signals that are received from a headend 110 (e.g., via network communication interface 242).
2. Broadcast digital compressed audio and/or video signals that are received from a headend 110 (e.g., via network communication interface 242).
3. Analog audio and/or video signals that are received from a consumer electronics device (e.g., an analog video camcorder) via a communication port 264 (e.g., an analog audio and video connector such as an S-Video connector or a composite video connector, among others).
4. An on-demand digital compressed audio and/or video stream that is received from a headend 110 (e.g., via network communication interface 242).
5. A digital compressed audio and/or video stream or digital non-compressed video frames that are received from a digital consumer electronic device (such as a personal computer or a digital video camcorder) via a communication port 264 (e.g., a digital video interface or a home network interface such as USB, IEEE-1394 or Ethernet, among others).
6. A digital compressed audio and/or video stream that is received from an externally connected storage device (e.g., a DVD player) via a communication port 264 (e.g., a digital video interface or a communication interface such as IDE, SCSI, USB, IEEE-1394 or Ethernet, among others).

The STT 200 includes signal processing system 214, which comprises a demodulating system 213 and a transport demultiplexing and parsing system 215 (herein referred to as the demultiplexing system 215) for processing broadcast media content and/or data. One or more of the components of the signal processing system 214 can be implemented with software, a combination of software and hardware, or hardware (e.g., an application specific integrated circuit (ASIC)).

Demodulating system 213 comprises functionality for demodulating analog or digital transmission signals. For instance, demodulating system 213 can demodulate a digital transmission signal in a carrier frequency that was modulated as a QAM-modulated signal. When tuned to a carrier frequency corresponding to an analog TV signal, the demultiplexing system 215 may be bypassed and the demodulated analog TV signal that is output by demodulating system 213 may instead be routed to analog video decoder 216. The analog video decoder 216 converts the analog TV signal into a sequence of digital non-compressed video frames (with the respective associated audio data; if applicable).

The compression engine 217 then converts the digital video and/or audio data into compressed video and audio streams, respectively. The compressed audio and/or video streams may be produced in accordance with a predetermined compression standard, such as, for example, MPEG-2, so that they can be interpreted by video decoder 223 and audio decoder 225 for decompression and reconstruction at a future time. Each compressed stream may comprise a sequence of data packets containing a header and a payload. Each header may include a unique packet identification code (PID) associated with the respective compressed stream.

The compression engine 217 may be configured to:
a) compress audio and video (e.g., corresponding to a video program that is presented at its input in a digitized non-compressed form) into a digital compressed form;
b) multiplex compressed audio and video streams into a transport stream, such as, for example, an MPEG-2 transport stream; and/or
c) compress and/or multiplex more than one video program in parallel (e.g., two tuned analog TV signals when STT 200 has multiple tuners).

In performing its functionality, the compression engine 217 may utilize a local memory (not shown) that is dedicated to the compression engine 217. The output of compression engine 217 may be provided to the signal processing system 214. Note that video and audio data may be temporarily stored in memory 249 by one module prior to being retrieved and processed by another module.

Demultiplexing system 215 can include MPEG-2 transport demultiplexing functionality. When tuned to carrier frequencies carrying a digital transmission signal, demultiplexing system 215 enables the extraction of packets of data corresponding to the desired video streams. Therefore, demultiplexing system 215 can preclude further processing of data packets corresponding to undesired video streams.

The components of signal processing system 214 are preferably capable of QAM demodulation, forward error correction, demultiplexing MPEG-2 transport streams, and parsing packetized elementary streams. The signal processing system 214 is also capable of communicating with processor 244 via interrupt and messaging capabilities of STT 200. Compressed video and audio streams that are output by the signal processing 214 can be stored in storage device 263, or can be provided to media engine 222, where they can be decompressed by the video decoder 223 and audio decoder 225 prior to being output to the television 140 (FIG. 1).

One having ordinary skill in the art will appreciate that signal processing system 214 may include other components not shown, including memory, decryptors, samplers, digitizers (e.g. analog-to-digital converters), and multiplexers, among others. Furthermore, components of signal processing system 214 can be spatially located in different areas of the STT 200.

Demultiplexing system 215 parses (i.e., reads and interprets) compressed streams (e.g., produced from compression engine 217 or received from headend 110 or from an externally connected device) to interpret sequence headers and picture headers, and deposits a transport stream (or parts thereof) carrying compressed streams into memory 249. The processor 244 works in concert with demultiplexing system 215, as enabled by the interrupt and messaging capabilities of STT 200, to parse and interpret the information in the compressed stream and to generate ancillary information.

In one embodiment, among others, the processor 244 interprets the data output by signal processing system 214 and generates ancillary data in the form of a table or data structure comprising the relative or absolute location of the beginning of certain pictures in the compressed video stream. Such ancillary data may be used to facilitate random access operations such as fast forward, play, and rewind starting from a correct location in a video stream.

A single demodulating system 213, a single demultiplexing system 215, and a single signal processing system 214, each with sufficient processing capabilities may be used to process a plurality of digital video streams. Alternatively, a plurality of tuners and respective demodulating systems 213, demultiplexing systems 215, and signal processing systems 214 may simultaneously receive and process a plurality of respective broadcast digital video streams.

As a non-limiting example, among others, a first tuner in tuning system 245 receives an analog video signal corresponding to a first video stream and a second tuner simultaneously receives a digital compressed stream corresponding to a second video stream. The first video stream is converted into a digital format. The second video stream and/or a compressed digital version of the first video stream may be stored in the storage device 263. Data annotations for each of the two streams may be performed to facilitate future retrieval of the video streams from the storage device 263. The first video stream and/or the second video stream may also be routed to media engine 222 for decoding and subsequent presentation via television 140 (FIG. 1).

A plurality of compression engines 217 may be used to simultaneously compress a plurality of analog video streams. Alternatively, a single compression engine 217 with sufficient processing capabilities may be used to compress a plurality of analog video streams. Compressed digital versions of respective analog video streams may be stored in the storage device 263.

In one embodiment, the STT 200 includes at least one storage device 263 for storing video streams received by the STT 200. The storage device 263 may be any type of electronic storage device including, for example, a magnetic, optical, or semiconductor based storage device. The storage device 263 preferably includes at least one hard disk 201 and a controller 269.

A PVR application 267, in cooperation with the device driver 211, effects, among other functions, read and/or write operations to the storage device 263. The controller 269 receives operating instructions from the device driver 211 and implements those instructions to cause read and/or write operations to the hard disk 201. Herein, references to write and/or read operations to the storage device 263 will be understood to mean operations to the medium or media (e.g., hard disk 201) of the storage device 263 unless indicated otherwise.

The storage device 263 is preferably internal to the STT 200, and coupled to a common bus 205 through an interface (not shown), such as, for example, among others, an integrated drive electronics (IDE) interface. Alternatively, the storage device 263 can be externally connected to the STT 200 via a communication port 264. The communication port 264 may be, for example, a small computer system interface (SCSI), an IEEE-1394 interface, or a universal serial bus (U SB), among others.

The device driver 211 is a software module preferably resident in the operating system 253. The device driver 211, under management of the operating system 253, communicates with the storage device controller 269 to provide the operating instructions for the storage device 263. As device drivers and device controllers are well known to those of ordinary skill in the art, further discussion of the detailed working of each will not be described further here.

In a preferred embodiment of the invention, information pertaining to the characteristics of a recorded video stream is contained in program information file 203 and is interpreted to fulfill the specified playback mode in the request. The program information file 203 may include, for example, the packet identification codes (PIDs) corresponding to the recorded video stream. The requested playback mode is implemented by the processor 244 based on the characteristics of the compressed data and the playback mode specified in the request.

Transfers of compressed data from the storage device to the media memory 224 are orchestrated in pipeline fashion. Video and/or audio streams that are to be retrieved from the storage device 263 for playback may be deposited in an output buffer corresponding to the storage device 263, transferred (e.g., through a DMA channel in memory controller 268) to memory 249, and then transferred to the media memory 224 (e.g., through input and output first-in-first-out (FIFO) buffers in media engine 222). Once the video and/or audio streams are deposited into the media memory 224, they may be retrieved and processed for playback by the media engine 222.

FIFO buffers of DMA channels act as additional repositories containing data corresponding to particular points in time of the overall transfer operation. Input and output FIFO buffers in the media engine 222 also contain data throughout the process of data transfer from storage device 263 to media memory 224.

The memory 249 houses a memory controller 268 that manages and grants access to memory 249, including servicing requests from multiple processes vying for access to memory 249. The memory controller 268 preferably includes DMA channels (not shown) for enabling data transfer operations.

The media engine 222 also houses a memory controller 226 that manages and grants access to local and external processes vying for access to media memory 224. Furthermore, the memory engine 222 includes an input FIFO (not shown) connected to data bus 205 for receiving data from external processes, and an output FIFO (not shown) for writing data to media memory 224.

In one embodiment of the invention, the operating system (OS) 253, device driver 211, and controller 269 cooperate to create a file allocation table (FAT) comprising information about hard disk clusters and the files that are stored on those clusters. The OS 253 can determine where a file's data is located by examining the FAT 204. The FAT 204 also keeps track of which clusters are free or open, and thus available for use.

The PVR application 267 provides a user interface that can be used to select a desired video presentation currently stored in the storage device 263. The PVR application 267 may also be used to help implement requests for trick mode operations in connection with a requested video presentation, and to provide a user with visual feedback indicating a current status of a trick mode operation (e.g., the type and speed of the trick mode operation and/or the current picture location relative to the beginning and/or end of the video presentation). Visual feedback indicating the status of a trick mode or playback operation may be in the form of a graphical presentation superimposed on the video picture displayed on the TV 140 (FIG. 1) (or other display device driven by the output system 248).

When a user requests a trick mode (e.g., fast forward, fast reverse, slow motion advance or reverse), the intermediate repositories and data transfer steps have traditionally caused a disparity in the video between the next location to be read from the storage device and the location in the video stream that is being output by the decoding system (and that corresponds to the current visual feedback). Preferred embodiments of the invention may be used to minimize or eliminate such disparity.

The PVR application 267 may be implemented in hardware, software, firmware, or a combination thereof. In a preferred embodiment, the PVR application 267 is implemented in software that is stored in memory 249 and that is executed by processor 244. The PVR application 267, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

When an application such as PVR application 267 creates (or extends) a video stream file, the operating system 253, in cooperation with the device driver 211, queries the FAT 204 for an available cluster for writing the video stream. As a non-limiting example, to buffer a downloaded video stream into the storage device 263, the PVR application 267 creates a video stream file and file name for the video stream to be downloaded. The PVR application 267 causes a downloaded video stream to be written to the available cluster under a particular video stream file name. The FAT 204 is then updated to include the new video stream file name as well as information identifying the cluster to which the downloaded video stream was written.

If additional clusters are needed for storing a video stream, then the operating system 253 can query the FAT 204 for the location of another available cluster to continue writing the video stream to hard disk 201. Upon finding another cluster, the FAT 204 is updated to keep track of which clusters are linked to store a particular video stream under the given video stream file name. The clusters corresponding to a particular video stream file may be contiguous or fragmented. A defragmentor, for example, can be employed to cause the clusters associated with a particular video stream file to become contiguous.

In addition to specifying a video stream and/or its associated compressed streams, a request by the PVR application 267 for retrieval and playback of a compressed video presentation stored in storage device 263 may specify information that includes the playback mode, direction of playback, entry point of playback (e.g., with respect to the beginning of the compressed video presentation), playback speed, and duration of playback, if applicable.

The playback mode specified in a request may be, for example, normal-playback, fast-reverse-playback, fast-forward-playback, slow-reverse-playback, slow-forward-playback, or pause-display. Playback speed is especially applicable to playback modes other than normal playback and pause display, and may be specified relative to a normal playback speed. As a non-limiting example, playback speed specification may be 2×, 4×, 6×, 10× or 15× for fast-forward or fast-reverse playback, where X means “times normal play speed.” Likewise, ⅛×, ¼× and ½× are non-limiting examples of playback speed specifications in requests for slow-forward or slow-reverse playback.

In response to a request for retrieval and playback of a compressed video stream stored in storage device 263 for which the entry point is not at the beginning of the compressed video stream, the PVR application 267 (e.g., while being executed by the processor 244) uses the index table 202, the program information file 203 (also known as annotation data), and/or a time value provided by the video decoder 223 to determine a correct entry point for the playback of the video stream. For example, the time value may be used to identify a corresponding video picture using the index table 202, and the program information file 203 may then be used to determine a correct entry point within the storage device 263 for enabling the requested playback operation. The correct entry point may correspond to a current picture identified by the time value provided by the video decoder, or may correspond to another picture located a pre-determined number of pictures before and/or after the current picture, depending on the requested playback operation (e.g., forward, fast forward, reverse, or fast reverse). For a forward operation, the entry point may correspond, for example, to a picture that is adjacent to and/or that is part of the same group of pictures as the current picture (as identified by the time value).

FIG. 3 is a block diagram depicting a non-limiting example of selected components of a headend 110 in accordance with one embodiment of the invention. The headend 110 is configured to provide the STT 200 with video and audio data via, for example, analog and/or digital broadcasts. As shown in FIG. 3, the headend 110 includes a VOD server 350 that is connected to a digital network control system (DNCS) 323 via a high-speed network such as an Ethernet connection 332.

The DNCS 323 provides management, monitoring, and control of the network's elements and of analog and digital broadcast services provided to users. In one implementation, the DNCS 323 uses a data insertion multiplexer 329 and a quadrature amplitude modulation (QAM) modulator 330 to insert in-band broadcast file system (BFS) data or messages into an MPEG-2 transport stream that is broadcast to STTs 200 (FIG. 1). Alternatively, a message may be transmitted by the DNCS 323 as a file or as part of a file.

A quadrature-phase-shift-keying (QPSK) modem 326 is responsible for transporting out-of-band IP (internet protocol) datagram traffic between the headend 110 and an STT 200. Data from the QPSK modem 326 is routed by a headend router 327. The DNCS 323 can also insert out-of-band broadcast file system (BFS) data into a stream that is broadcast by the headend 110 to an STT 200. The headend router 327 is also responsible for delivering upstream application traffic to the various servers such as, for example, the VOD server 350. A gateway/router device 340 routes data between the headend 110 and the Internet.

A service application manager (SAM) server 325 is a server component of a client-server pair of components, with the client component being located at the STT 200. Together, the client-server SAM components provide a system in which the user can access services that are identified by an application to be executed and a parameter that is specific to that service. The client-server SAM components also manage the life cycle of applications in the system, including the definition, activation, and suspension of services they provide and the downloading of applications to an STT 200 as necessary.

Applications on both the headend 110 and an STT 200 can access the data stored in a broadcast file system (BFS) server 328 in a similar manner to a file system found in operating systems. The BFS server 328 repeatedly sends data for STT applications on a data carousel (not shown) over a period of time in a cyclical manner so that an STT 200 may access the data as needed (e.g., via an “in-band radio-frequency (RF) channel” or an “out-of-band RF channel”).

The VOD server 350 may provide an STT 200 with a VOD program that is transmitted by the headend 110 via the network 130 (FIG. 1). During the provision of a VOD program by the VOD server 350 to an STT 200 (FIG. 1), a user of the STT 200 may request a trick-mode operation (e.g., fast forward, rewind, etc.). Data identifying the trick-mode operation requested by a user may be forwarded by the STT 200 to the VOD server 350 via the network 130.

In response to user input requesting retrieval and playback of a compressed video stream stored in storage device 355 for which the entry point is not at the beginning of the compressed video stream, the VOD server 350 may use a value provided by the STT 200 to determine a correct entry point for the playback of the video stream. For example, a time value (e.g., corresponding to the most recently decoded video frame) provided by the video decoder 223 (FIG. 2) of the STT 200 may be used by the VOD server 350 to identify the location of a video picture (e.g., within the storage device 355) that represents the starting point for providing the requested trick-mode operation.

A time value provided by the STT 200 to the VOD server 350 may be relative to, for example, a beginning of a video presentation being provided by the VOD server 350. Alternatively, the STT 200 may provide the VOD server 350 with a value that identifies an entry point for playback relative to a storage location in the storage device 355.

FIG. 4 depicts a non-limiting example of a method 400 in accordance with one embodiment of the present invention. In step 401, the STT 200 receives a video stream (e.g., an MPEG-2 stream) and stores it on hard disk 201. The video stream may have been received by the STT 200 from, for example, the headend 110 (FIG. 1). The video stream may be made up of multiple picture sequences, wherein each picture sequence has a sequence header, and each picture has a picture header. The beginning of each picture and picture sequence may be determined by a start code.

As the video stream is being stored in hard disk 201, each picture header is tagged with a time value, as indicated in step 402. The time value, which may be provided by an internal running clock or timer, preferably indicates the time period that has elapsed from the time that the video stream began to be recorded. Alternatively, each picture header may be tagged with any value that represents the location of the corresponding picture relative to the beginning of the video stream. The sequence headers may also be tagged in a similar manner as the picture headers.

In addition to tagging the picture headers and/or sequence headers with time values, an index table 202 is created for the video stream, as indicated in step 403. The index table 202 associates picture headers with respective time values, and facilitates the delivery of selected data to the media engine 222. The index table 202 may include some or all of the following information about the video stream:
a) The storage location of each of the sequence headers.
b) The storage location of each picture start code.
c) The type of each picture (I, P, or B).
d) The time value that was used for tagging each picture.

FIG. 5 depicts a non-limiting example of a method 500 in accordance with one embodiment of the present invention. In step 501, a request for play-back of a recorded video presentation is received. In response to receiving the play-back request, a picture corresponding to the recorded video presentation is provided to the video decoder, as indicated in step 502. A stuffing transport packet (STP) containing a time value (e.g., as provided in step 402 (FIG. 4)) is then provided to the video decoder, as indicated in step 503. The STP is a video packet comprising a PES (packetized elementary stream) header, a user start code, and the time value (corresponding to the picture provided in step 502). While the play-back is still in effect, steps 502 and 503 are repeated (i.e., additional pictures and respective STPs are provided to the video decoder).

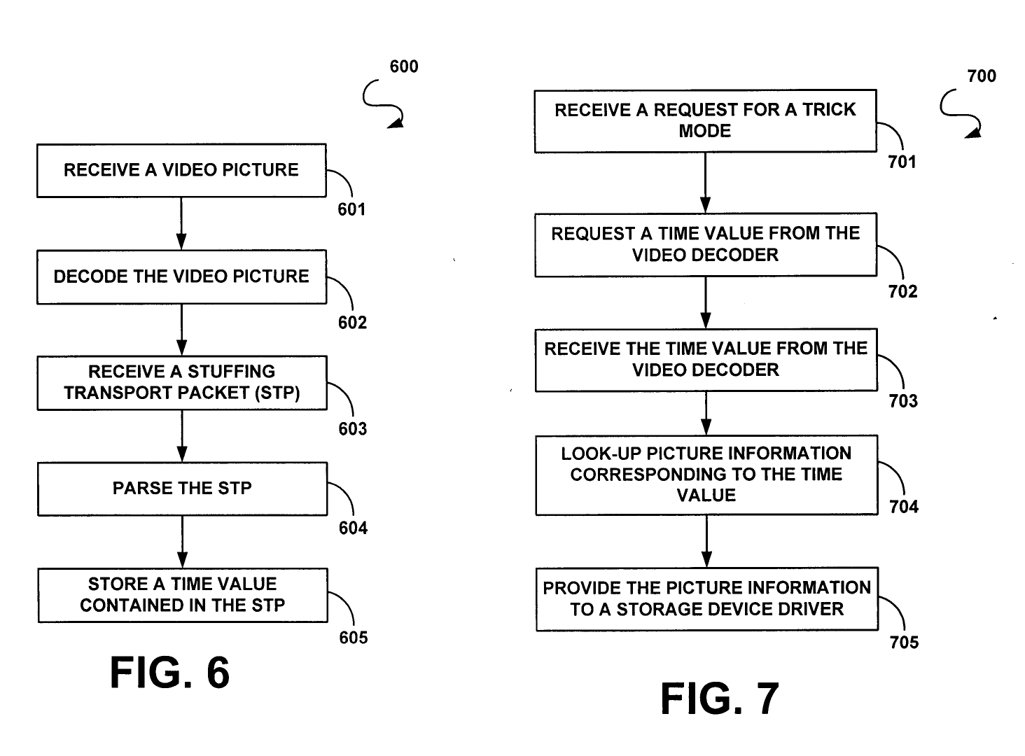

FIG. 6 depicts a non-limiting example of a method 600 in accordance with one embodiment of the present invention. The video decoder receives a video picture, as indicated in step 601, and then decodes the video picture, as indicated in step 602. The video decoder also receives a stuffing transport packet (STP), as indicated in step 603, and then parses the STP, as indicated in step 604. After parsing the STP, the video decoder stores in memory a time value contained in the STP, as indicated in step 605. This time value may then be provided to the PVR application 267 to help retrieve video pictures starting at a correct location in a recorded television presentation (e.g., as described in reference to FIG. 7).

FIG. 7 depicts a non-limiting example of a method 700 in accordance with one embodiment of the present invention. In step 701, the PVR application 267 receives a request for a trick mode. In response to receiving the request for a trick mode, the PVR application 267 requests a time value from the video decoder, as indicated in step 702. The requested time value corresponds to a video picture that is currently being presented to the television 140.

After receiving the time value from the video decoder, as indicated in step 703, the PVR application 267 looks-up picture information (e.g., a pointer indicating the location of the picture) that is responsive to the time value and to the requested trick-mode, as indicated in step 704. For example, if the requested trick-mode is fast-forward, then the PVR application 267 may look-up information for a picture that is a predetermined number of pictures following the picture corresponding to the time value. The PVR application 267 then provides this picture information to a storage device driver, as indicated in step 705. The storage device driver may then use this information to help retrieve the corresponding picture from the hard disk 201.

The PVR application 267 may use the index table 202, the program information file 203, and/or the time value provided by the video decoder 223 to determine the correct entry point for the playback of the video stream. For example, the time value may be used to identify a corresponding video picture using the index table 202, and the program information file 203 may then be used to determine the location of the next video picture to be retrieved from the storage device 263.

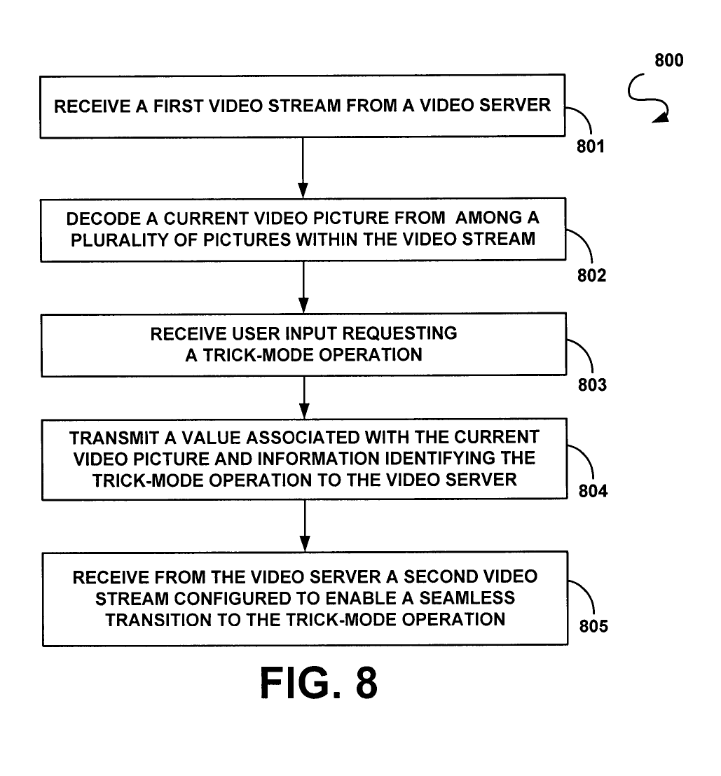

FIG. 8 depicts a non-limiting example of a method 800 in accordance with one embodiment of the present invention. In step 801, a first video stream (comprising a plurality of pictures) is received from a video server. A current video picture from among the plurality of video pictures is decoded, as indicated in step 802. User input requesting a trick-mode operation is then received, as indicated in step 803. A value associated with the current video picture and information identifying the trick mode operation is transmitted to the video server responsive to the user input, as indicated in step 804. Then, in step 805, a second video stream configured to enable a seamless transition to the trick-mode operation is received from the video server responsive to the information transmitted in step 804.

The steps depicted in FIGS. 4-8 may be implemented using modules, segments, or portions of code which include one or more executable instructions. In an alternative implementation, functions or steps depicted in FIGS. 4-8 may be executed out of order from that shown or discussed, including substantially concurrently or in reverse order, depending on the functionality involved, as would be understood by those of ordinary skill in the art.

The functionality provided by the methods illustrated in FIGS. 4-8, can be embodied in any computer-readable medium for use by or in connection with a computer-related system (e.g., an embedded system) or method. In this context of this document, a computer-readable medium is an electronic, magnetic, optical, semiconductor, or other physical device or means that can contain or store a computer program or data for use by or in connection with a computer-related system or method. Furthermore, the functionality provided by the methods illustrated in FIGS. 4-8 can be implemented through hardware (e.g., an application specific integrated circuit (ASIC) and supporting circuitry), software, or a combination of software and hardware.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the preferred embodiments of the invention in logic embodied in hardware and/or software-configured mediums.

1. A method for providing a seamless transition between video play-back modes, comprising the steps of:
storing a video stream in memory;
receiving a request for a trick mode operation;
responsive to receiving the request for a trick mode operation, using information provided by a video decoder to identify a first video picture to be decoded;
decoding the first video picture; and
outputting the first video picture to a display device.

2. The method of claim 1, further comprising decoding and outputting a second video picture, wherein the first video picture and the second video picture are part of a group of pictures.

3. The method of claim 1, wherein the information provided by the video decoder is a time value that is associated with the first video picture.

4. The method of claim 1, wherein the first video picture is adjacent in display order to another video picture that was being output to the display device when the request for the trick mode operation was received.

5. The method of claim 1, wherein the video stream is received from a headend.

6. The method of claim 1, wherein the memory is a non-volatile memory.

7. The method of claim 1, further comprising storing information related to the video stream in memory.

8. The method of claim 7, wherein a demultiplexing system uses data embedded in the video stream to generate the information related to the video stream.

9. The method of claim 7, wherein the information related to the video stream comprises an index table.

10. The method of claim 9, wherein the index table identifies when each of a plurality of pictures within the video stream was stored in memory relative to a point in time.

11. The method of claim 10, wherein the point in time corresponds to when recording of the video stream commences.

12. The method of claim 9, wherein the index table associates time values with respective video pictures within the video stream.

13. The method of claim 9, wherein the index table associates values with respective video pictures within the video stream, the values being indicative of a display order of the pictures within the video stream.

14. The method of claim 9, wherein the index table identifies storage locations of respective picture start codes.

15. The method of claim 9, wherein the index table identifies picture types.

16. The method of claim 9, wherein the index table identifies storage locations of respective sequence headers.

17. The method of claim 1, wherein the trick mode operation is one of a fast play mode, a rewind mode, or a play mode.

18. The method of claim 1, wherein the information provided by the video decoder identifies a normal playback time required to reach the first video picture from a beginning of the video stream.

19. The method of claim 1, further comprising:
examining information in an index table;
examining annotation data corresponding to the video stream; and
determining an entry point for fulfilling the trick mode request responsive to the annotation data and the information in the index table.

20. The method of claim 1, wherein the method is implemented by a television set-top terminal, and wherein the display device is a television.

21. A method comprising the steps of:
receiving a first video stream from a video server, the video stream comprising a plurality of video pictures;
decoding a current video picture from among the plurality of video pictures;
receiving user input requesting a trick-mode operation;
transmitting a value associated with the current video picture and information identifying the trick mode operation to the video server; and
receiving from the video server a second video stream configured to enable a seamless transition to the trick-mode operation.

22. The method of claim 21, wherein the value associated with the current video picture is a time value.

23. The method of claim 22, wherein the time value is relative to a beginning of the first video stream.

24. The method of claim 21, wherein the value associated with the current video picture enables identification of a storage location corresponding to the video picture.

25. The method of claim 21, wherein the trick mode operation is one of a fast play mode, a rewind mode, or a play mode.

26. The method of claim 21, wherein:
the method is implemented by a television set-top terminal;
the display device is a television; and
the video server is located at a headend.

27. The method of claim 21, wherein one of the video pictures in the second video stream is temporally adjacent to the current video picture.

28. A method for providing a seamless transition between video play-back modes, comprising the steps of:
decoding a current video picture;
parsing a stuffing transport packet (STP) comprising a time value corresponding to the current video picture; and
storing the time value in memory.

29. The method of claim 28, further comprising:
using the time value to identify a location from which to begin a trick mode operation within a video presentation.

30. The method of claim 29, wherein the location corresponds to the current video picture.

31. The method of claim 29, wherein the location corresponds to a video picture that is adjacent in display order to the current video picture.

32. The method of claim 28, wherein the trick mode operation is one of a fast play mode, a rewind mode, or a play mode.

33. The method of claim 28, wherein the time value is correlated to a normal play-time from a beginning of a video stream to the current video picture.

34. The method of claim 28, wherein the method is implemented by a video decoder.

35. A system for providing a seamless transition between video play-back modes, comprising:
a memory device for storing a video stream that includes a current video picture;
a processor that is coupled to the memory device; and
a video decoder that is coupled to the processor, and that is configured to:
decode the current video picture,
parse a stuffing transport packet (STP) that includes a time value corresponding to the current video picture, and
store the time value.

36. The system of claim 35, wherein the processor is programmed to use the time value to identify a location from which to begin a trick mode operation within a video presentation.

37. The system of claim 36, wherein the location corresponds to the current video picture.

38. The system of claim 36, wherein the location corresponds to a video picture that is adjacent in display order to the current video picture.

39. The system of claim 35, wherein the trick mode operation is one of a fast play mode, a rewind mode, or a play mode.

40. The system of claim 35, wherein the time value is correlated to a normal play-time from a beginning of the video stream to the current video picture.

41. A method for providing a seamless transition between video play-back modes, comprising the steps of:
storing a video stream in memory;
storing information related to the video stream in memory;
receiving a request for a trick mode operation;
responsive to receiving the request for a trick mode operation, using information provided by a video decoder to identify a first video picture to be decoded;
decoding the first video picture;
outputting the first video picture to a display device;
decoding and outputting a second video picture, wherein the first video picture and the second video picture are part of a group of pictures;
wherein the information provided by the video decoder is a time value that is associated with the first video picture;
wherein the first video picture is adjacent in display order to another video picture that was being output to the display device when the request for the trick mode operation was received;
wherein the video stream is received from a headend;
wherein the memory is a non-volatile memory;
wherein the information related to the video stream comprises an index table;
wherein the index table associates time values with respective video pictures within the video stream;
wherein the index table identifies storage locations of respective picture start codes;
wherein the index table identifies picture types;
wherein the index table identifies storage locations of respective sequence headers;
wherein the trick mode operation is one of a fast play mode, a rewind mode, or a play mode;
wherein the information provided by the video decoder identifies a normal playback time required to reach the first video picture from a beginning of the video stream;
wherein in response to the request, a processor reads information in an index table and determines an entry point for fulfilling the trick mode request; and
wherein the method is implemented by a television set-top terminal.
